(19) United States
(12) Patent Application Publication
(10) Pub. No.: US 2004/0154871 A1
(43) Pub. Date: Aug. 12, 2004

(54) Method for operating a fork-lift truck

(76) Inventors: Uwe Allerding, Ehbsen (DE); Matthias Duewel, Hamburg (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/775,422

(22) Filed: Feb. 10, 2004

(30) Foreign Application Priority Data
Feb. 12, 2003 (DE) 103 05 671.8
Feb. 13, 2003 (DE) 103 05 901.6
Feb. 13, 2003 (DE) 103 05 900.8

(51) Int. Cl. B66B 5/06

(52) U.S. Cl. 187/287

(57) ABSTRACT

A method for operating a fork-lift truck the lift mast of which that guides a load-carrying means is provided for regulating the lateral position, the inclination and/or the angular position of the load-carrying means relative to the lift mast, wherein the driving speeds of the drives have a maximum upper limit when the load-carrying means is in its highest position, wherein the height of the load-carrying means is measured by steps or continuously and the maximum acceleration/deceleration and/or the maximum speed of at least one drive increases with a decreasing height of the load-carrying means.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

So-called fork-lift reach trucks have a mast on which the load-carrying means is guided adjustably in height and which can be moved away from and towards the driving portion by means of an appropriate hydraulic drive (mast extraction). In addition, the mast is variable in its inclination by means of an inclination drive. Further, the load-carrying means can be moved sidewards relative to the mast (side loader). In addition, special fork-lift reach trucks are known in which the entire the load-carrying means can be pivoted through a maximum of 90° from the initial position. Appropriate drives are provided also for this purpose. At last, it is known to vary the inclination of the fork of the load-carrying means.

Such fork-lift trucks are employed in stores in which the loads sometimes require to be moved to very large heights. This is why the masts of such fork-lift trucks exhibit one or two lifting sections in order to be extractable up to a height of 12 m or more. Vehicles of this type are naturally provided with a travelling drive. The stability of position of such vehicles is naturally dependent, amongst other things, on the height of the mast or mast receiving means, the mast inclination and,

of course, the weight of the load as well. It is known to vary the driving speed and the cornering speed in dependence on the weight of the load and/or the height of the load-carrying means.

From U.S. Pat. No. 6,425,728 B1, it is known to choose the speed of a regulation of the mast inclination in dependence on the height of the load-carrying means and/or the weight of the load.

Further, it is known to set a predetermined speed for a regulation of the mast and load-carrying means in dependence on the maximum or nominal load and the maximum height of a load-carrying means. This is done either via a software in the control of the fork-lift truck or via hydraulic means for limiting the hydraulic medium. Finally, it is also known to make the travelling or cornering speed of the vehicle be dependent on the height of the load and the weight of the load.

It is the object of the invention to provide a method for operating a fork-lift truck which allows to increase the efficiency in handling loads.

### BRIEF SUMMARY OF THE INVENTION

In the invention, the height of the load-carrying means is measured by steps and/or continuously and the maximum acceleration/deceleration and/or the maximum speed of at least one drive will increase with a decreasing height of the load-carrying means.

In the solution of claim 2, the weight of the load is measured on the load-carrying means and the maximum acceleration/deceleration and/or the maximum speed of at least one drive will increase with a decreasing weight of the load-carrying means.

According to the invention, the functions of the speed of one or more drives can be combined into an interlinked function in dependence on the height of the load-carrying means and the weight of the load in order to carry out optimum handling procedures with sufficient safety.

The functions described for the load-carrying means and mast are also described as secondary functions except for the lifting function, which is also called the main function. In the invention, all of the secondary function speeds and/or accelerations/decelerations of the secondary function drives can be controlled in dependence on the load and/or lifting height.

### BRIEF DESCRIPTION OF THE SEVERAL VIEW THE DRAWINGS

The invention will be described in more detail below with reference to graphs.

FIG. 1 shows a graph for the secondary function speed in dependence on the height of the load-carrying means with the height of the load-carrying means being measured by steps.

FIG. 2 shows a representation similar to FIG. 1, but with the height of the load-carrying means being measured continuously.

FIG. 3 shows a graph of the secondary function speed in dependence on the weight of the load.

FIG. 4 shows a representation similar to FIG. 3, but with the weight of the load sensed continuously.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

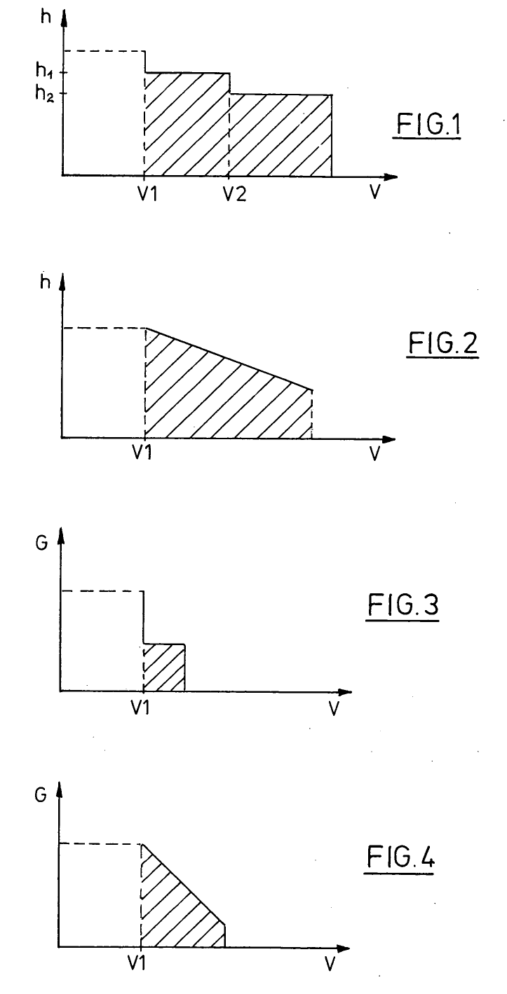

The functions illustrated in FIGS. 1 to 4 represent the secondary function speed in general with individual speeds of the drives for the extraction of the most, fork inclination, side shift of the load-carrying means, etc. also being controllable, however.

In FIG. 1, it can be seen that the speed does not exceed v1 when the load-carrying means is at its maximum height. However, when a smaller height is measured for the load-carrying means, e.g. by steps using switches on the mast, there will be a larger possible speed each for the secondary functions at the heights h1 and h2. The hatched area represents the advantage in speed.

When the height of the load-carrying means is measured continuously it is natural that the speed of the secondary functions can be adapted continuously. This is illustrated in FIG. 2.

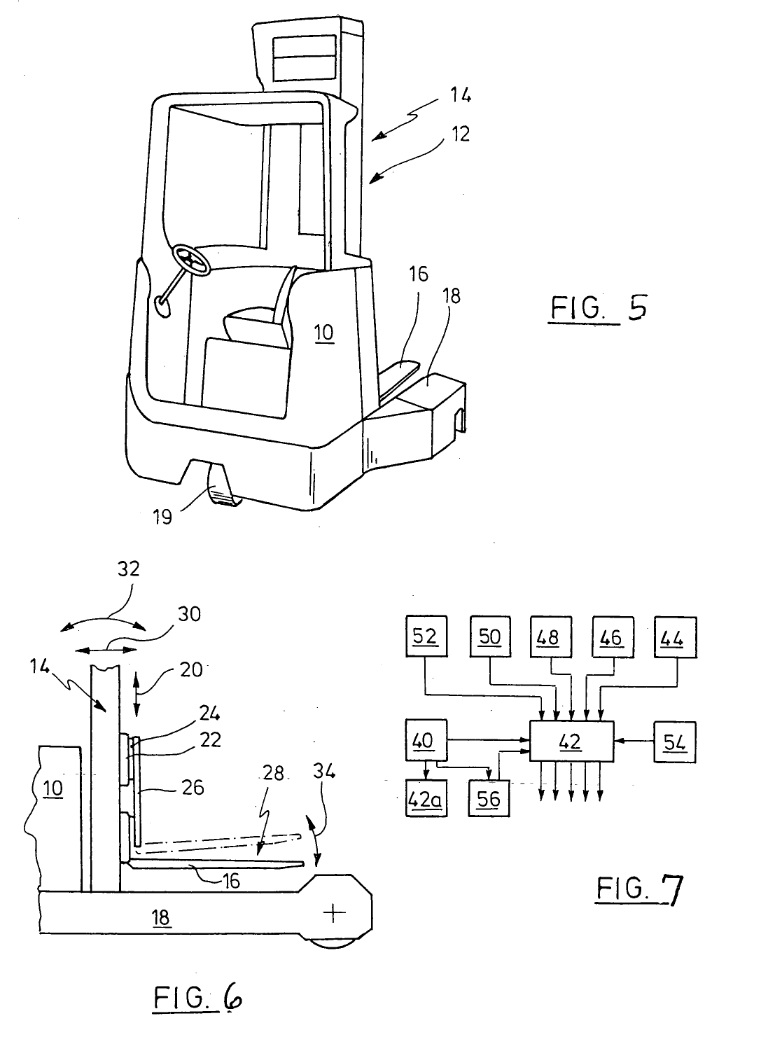

Naturally, the speed can also be varied in dependence on the weight of the load, which is illustrated in FIGS. 3 and 4. When the weight of the load is measured by steps, for example, it becomes possible to increase the speed of the secondary functions by steps as is shown in FIG. 3. When the weight of the load is sensed continuously it is possible to adapt the speed of the secondary functions continuously (FIG. 4). The decisive factor for the stability of position of a fork-lift truck as far as it is influenced by the regulation of the secondary functions is even more the dynamics which results in case of a speed variation, i.e. the acceleration and deceleration of the masses moved by the respective drive. A deceleration will result from braking in the vicinity of a preset position, e.g. that of the mast during an advance motion, the sideward displacement of the load-carrying means, etc. Once a predetermined speed is reached it will no longer affect the stability of position of the fork-lift truck until another acceleration or braking action is initiated. The crucial point is the acceleration or deceleration at which the movement of a secondary function is performed. Acceleration is commonly performed via the torque of the driving motor. The higher the driving torque is the larger is acceleration. Conversely, deceleration depends on the braking torque. Naturally, these parameters can also be made variable in dependence on the lifting height measured and the weight measured for the load.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. The method for operating a fork-lift truck the lift mast of which that guides a load-carrying means is provided with at least one extraction drive and in which more drives are provided, in case of need, for regulating the lateral position, the inclination and/or the angular position of the load-carrying means relative to the lift mast, wherein the driving speeds of the drives have a maximum upper limit when the load-carrying means is in its highest position, characterized in that the height of the load-carrying means is measured by steps or continuously and the maximum acceleration/deceleration and/or the maximum speed of at least one drive increases with a decreasing height of the load-carrying means.

2. The method for operating a fork-lift truck the lift mast of which that guides a load-carrying means is provided with at least one extraction drive and in which more drives are provided, in case of need, for regulating the lateral position, the inclination and/or the angular position of the load-carrying means relative to the lift mast, wherein the driving speeds of the drives have a maximum upper limit when the load-carrying means is in its highest position, characterized in that the weight of the load is measured on the load-carrying means and the maximum acceleration/deceleration and/or the maximum speed of at least one drive increases with a decreasing weight of the load.

3. The method as claimed in claim 1, characterized in that an interlinking function is formed from the two functions of the maximum acceleration/deceleration and/or that of the maximum speed of at least one drive in dependence of the lift-height and the weight of the load, according to which function the acceleration/deceleration and/or speed of at least one drive is set.

4. The method as claimed in claim 2, characterized in that an interlinking function is formed from the two functions of the maximum acceleration/deceleration and/or that of the maximum speed of at least one drive in dependence of the lift height and the weight of the load, according to which function the acceleration/deceleration and/or speed of at least one drive is set.
